(19) United States
(12) Patent Application Publication
(10) Pub. No.: US 2007/0161487 A1
(43) Pub. Date: Jul. 12, 2007

(54) Apparatus and method for forming a discontinuity in an interfolded stack

(76) Inventors: Chad L. Ryczek, Oconto Falls, WI (US); Michael T. Sandor, Washburn, WI (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/329,349

(22) Filed: Jan. 10, 2006

(51) Int. Cl. B31F 1/10

(52) U.S. Cl. 493/427

(57) ABSTRACT

An interfolding apparatus including first and second interfolding rolls. The first interfolding roll is supplied sheets of web product and the second interfolding roll is supplied additional sheets of web product. The interfolding rolls rotate to form a first number of folds in the sheets and rotate to form the first number of folds in some of the additional sheets and a second, different number of folds in at least one other of the additional sheets. The interfolding rolls rotate to interfold the sheets with the additional sheets having the first number of folds to form a stack of interfolded web product and rotate to interfold at least one of the sheets with at least one of the additional sheets having the second number of folds to form a discontinuity in the stack.

### FIELD OF THE INVENTION

The invention relates to apparatuses and methods for interfolding sheets of web product to create a stack of interfolded sheets and to form a separation or discontinuity between the sheets of the stack.

### BACKGROUND OF THE INVENTION

A typical interfolding apparatus has two rotating interfolding rolls that issue a stream of interfolded web material. In operation, separate streams of web material are delivered to individual cutting rolls where the web material is cut into sheets. The sheets then move downward to corresponding interfolding rolls that are positioned to form a nip. The interfolding rolls rotate in opposite directions and receive the newly-cut sheets of web material from the cutting rolls.

The sheets are usually staggered with respect to the first and second interfolding rolls so that a middle portion of a first sheet of one roll passes through the nip at approximately the same time as leading and trailing edges of sheets of the opposite roll. At this time, vacuum or mechanical grippers of the first roll attract and retain the center of the first sheet and the leading and trailing edges of the opposing sheets to begin a fold in the first sheet and to capture the leading and trailing edges within the fold.

As the gripper rotates with the sheet, a packer finger pushes the middle portion along with the leading and trailing edges from the gripper to a position where the fold can be pressed with the leading and trailing edges of the opposing sheets being folded within the middle portion. This process continues alternately with the other interfolding roll to form an interfolded stack of material.

A specific number of sheets are typically counted for packaging purposes. Elements commonly referred to as count fingers and package building fingers can be used to separate a stack with a desired number of sheets. The count fingers are inserted sequentially from opposite sides into the stack of interfolded web material to create a clip below the count fingers having a known quantity of items. The inserted count fingers separate from each other to separate the interfolded sheets of the adjacent stacks.

### SUMMARY

One embodiment of the present invention provides an interfolding apparatus including first and second interfolding rolls. The first interfolding roll is supplied sheets of web product and the second interfolding roll is supplied additional sheets of web product. The interfolding rolls rotate to form a first number of folds in the sheets and rotate to form the first number of folds in some of the additional sheets and a second, different number of folds in at least one other of the additional sheets. The interfolding rolls rotate to interfold the sheets with the additional sheets having the first number of folds to form a stack of interfolded web product and rotate to interfold at least one of the sheets with at least one of the additional sheets having the second number of folds to form a discontinuity in the stack.

Another embodiment of the present invention provides an interfolding apparatus including a first interfolding roll supplied sheets of web product having a first length, and a second, adjacent interfolding roll supplied additional sheets of web product. Some of the additional sheets have the first length and at least one other of the additional sheets has a second, different length. The interfolding rolls rotate to interfold the sheets with the additional sheets having the first length to form a stack of interfolded web product, and the interfolding rolls are rotatable to interfold the sheets with at least one of the additional sheets having the second length to form a discontinuity in the stack.

In yet another embodiment, the present invention provides a method of interfolding sheets of web product. The method includes providing an interfolding apparatus including a first interfolding roll and a second interfolding roll adjacent to the first interfolding roll, supplying sheets of web product having a first length to the first interfolding roll, supplying some additional sheets of web product having the first length to the second interfolding roll, and supplying at least one other of the additional sheets of web product having a second, different length to the second interfolding roll, interfolding the sheets with the additional sheets having the first length, forming a stack of interfolded web product, interfolding the sheets with at least one of the additional sheets having the second length, and forming a discontinuity in the stack.

Other embodiments of the present invention include a method of interfolding sheets of web product. The method includes providing an interfolding apparatus including a first interfolding roll and a second interfolding roll adjacent to the first interfolding roll, supplying sheets of web product to the first interfolding roll, supplying additional sheets of web product to the second interfolding roll, forming a first number of folds in the sheets, forming the first number of folds in some of the additional sheets, forming a second, different number of folds in at least one other of the additional sheets, interfolding the sheets with the additional sheets having the first number of folds, forming a stack of interfolded web product, interfolding at least one of the sheets with at least one of the additional sheets having the second number of folds, and forming a discontinuity in the stack.

Independent features and independent advantages of the present invention will become apparent to those skilled in the art upon review of the following detailed description, claims, and drawings.

### BRIEF DESCRIPTION OF THE DRAWINGS

In the drawings, wherein like reference numerals indicate like parts:

FIG. 1 is a side view of the interfolding apparatus of the present invention; and

FIG. 2 is an enlarged side view of the stack of interfolded web product shown in FIG. 1.

Before at least one embodiment of the invention is explained in detail, it is to be understood that the invention is not limited in its application to the details of construction and the arrangements of components set forth in the following description or illustrated in the drawings. The invention is capable of other constructions and of being practiced or of being carried out in various ways.

Also, it is to be understood that the phraseology and terminology used herein with reference to element orientation are only used to simplify description of the present invention, and do not alone indicate or imply that the element referred to must have a particular orientation. In addition, terms such as “first” and “second” are used herein for purposes of description and are not intended to indicate or imply relative importance or significance.

### DETAILED DESCRIPTION

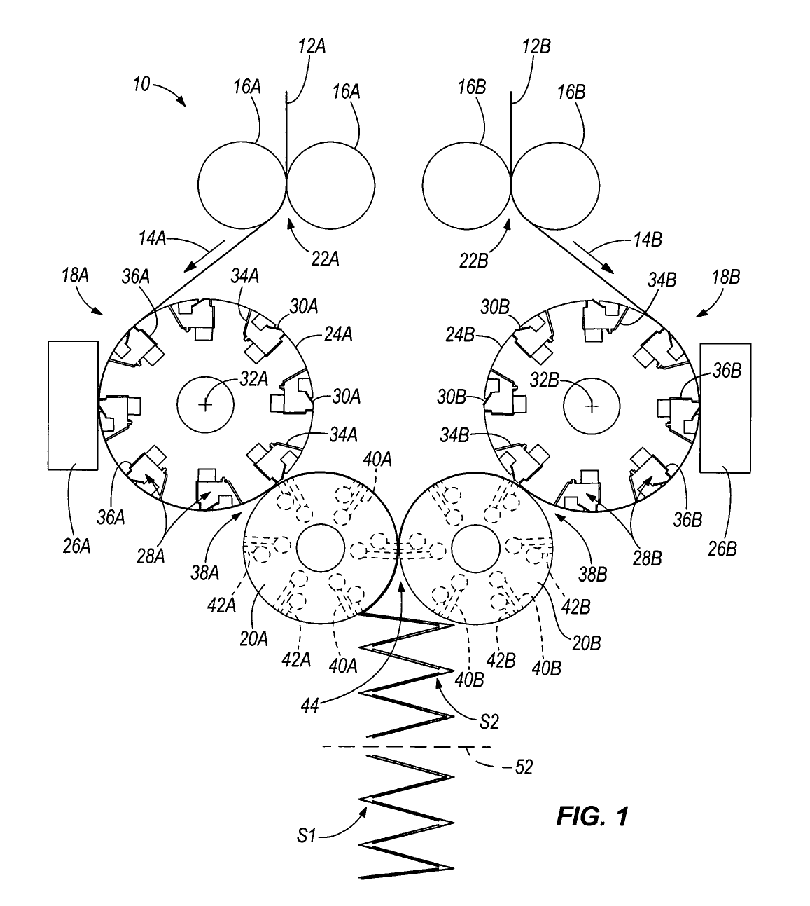

FIG. 1 illustrates an interfolding apparatus 10 operable to manipulate two streams of web material 12A, 12B in downstream directions to create stacks of interfolded web product. The downstream direction is identified by arrows 14A, 14B. The interfolding apparatus 10 includes a first set of rotatable guide rolls 16A, a first cutting assembly 18A located downstream of the first set of guide rolls 16A, and a first rotatable interfolding roll 20A located downstream of the first cutting assembly 18A. The interfolding apparatus 10 also includes a second set of rotatable guide rolls 16B, a second cutting assembly 18B located downstream of the second set of guide rolls 16B, and a second rotatable interfolding roll 20B located downstream of the second cutting assembly 18B.

The guide rolls 16A are positioned adjacent each other and define a nip 22A. The first guide rolls 16A are rotatable in opposite directions. The second set of guide rolls 16B is substantially similar to the first set of guide rolls 16A. The guide rolls 16A, 16B can be passive rolls used to direct and guide the web 12A, 12B, or can be active powered rolls that additionally pull the web, positively feeding it in the downstream direction to the cutting assemblies 18A, 18B.

The first cutting assembly 18A includes a rotatable cutting roll 24A and an anvil bar 26A. The cutting roll 24A rotates counter-clockwise and includes eight knife stations 28A about its periphery. Each knife station 28A includes a blade 30A selectively adjustable between retracted and extended positions relative to an axis 32A of the cutting roll 24A. The blade 30A can be actuated using an electronically-actuated solenoid, electric motor, servo-motor, air bladder, air cylinder, cams, linkages or the like. When in the extended position, the extended blade 30A will contact the anvil bar 26A during rotation of the cutting roll 24A. In contrast, the blade 30A will not contact the anvil bar 26A during rotation of the cutting roll 24A when in the retracted position. A more detailed explanation of a similar adjustable cutting blade system is provided in U.S. Pat. No.6,296,601, which is assigned to the same assignee as the present application. The entire contents of this patent is incorporated by reference into this application.

The cutting roll 24A also includes two vacuum passageways 34A, 36A associated with each knife station 28A. Specifically, a first, or downstream vacuum passageway 34A is located downstream of the blade 30A and a second, or upstream vacuum passageway 36A is located upstream of the blade 30A. Vacuum pressure can be selectively applied to each of the vacuum passageways through a pump and valve system (not shown). The second cutting assembly 18B is a substantial mirror image of the first cutting assembly 18A except that the cutting roll 24B of the second cutting assembly 18B rotates about an axis 32B in a clockwise direction.

Although both rolls 24A, 24B are described and illustrated as including actuable blades 30A, 30B, other configurations can also be used with the present invention. For example, one of the two cutting rolls 24A, 24B could include all non-actuable, or fixed blades. Also, the cutting rolls 24A, 24B could each include any combination of fixed and actuable blades located about the periphery of the cutting roll 24A, 24B. In addition, although eight knife stations 28A, 28B are shown on each roll 24A, 24B of the illustrated embodiment, it is within the scope of the present invention to instead use more or less knife stations 28A, 28B on each cutting roll 24A, 24B.

The first interfolding roll 20A rotates clockwise and is positioned adjacent to the first cutting roll 24A to define a nip 38A. The first interfolding roll 20A includes a plurality of vacuum port sets. Each set of vacuum ports includes a first, leading port 40A and a second, trailing port 42A. Vacuum pressure can be selectively applied to each of the vacuum ports 40A, 42A through a pump and valve system (not shown). The second interfolding roll 20B is substantially similar to the first interfolding roll 20A except that the second interfolding roll 20B rotates counter-clockwise and is positioned adjacent to the second cutting roll 24B to define a nip 38B. In other embodiments, the vacuum ports 40A, 40B, 42A, 42B on the interfolding rolls can be replaced by a mechanical gripper and tucker system.

FIG. 1 illustrates the operation of the interfolding apparatus 10 to build continuous interfolded stacks S1, S2. The first guide rolls 16A receive the web product 12A from a parent roll (not shown) positioned and unwound upstream of the interfolding apparatus 10. The first guide rolls 16A rotate to guide and direct the web product 12A through the nip 22A toward the first cutting assembly 18A.

The first cutting roll 24A rotates counter-clockwise and includes four blades 30A extended and four blades 30A retracted in an alternating configuration. Therefore, assuming the blades 30A are numbered consecutively, blades one, three, five, and seven are extended and blades two, four, six, and eight are retracted. As the web 12A is delivered to the periphery of the cutting roll 24A, the web 12A is gripped by the vacuum provided through the vacuum passageways 34A, 36A such that the web 12A is rotated and carried with the cutting roll 24A. As the cutting roll 24A continues to rotate with the web 12A, the extended blades 30A will contact the anvil bar 26A thereby creating a clean cut across the web 12A that is positioned between the blade 30A and the anvil bar 26A. The cut defines a trailing edge of a sheet immediately downstream of the cut, and defines a leading edge of the web product 12A immediately upstream of the cut. The downstream vacuum passageway 34A continues to hold the trailing edge of the downstream sheet, and the upstream vacuum passageway 36A continues to hold the leading edge of the web 12A.

As the next consecutive retracted blade 30A rotates passed the anvil bar 26A, the retracted blade 30A will not contact the anvil bar 26A and therefore will not cut the web 12A positioned between the retracted blade 30A and the anvil bar 26A. Although the blade 30A is retracted, the vacuum passageways 34A, 36A in the knife station 28A hold the web 12A as it rotates passed the anvil bar 26A. Rotation of the cutting roll 24A can continuously create sheets downstream of the anvil bar 26A. The sheets have a first length equal to the distance between two consecutive extended blades 30A along the periphery of the cutting roll 24A.

Next, the cut sheets are transferred in the nip 38A from the cutting roll 24A to the first interfolding roll 20A. As the sheet is moved through the nip 38A, the downstream vacuum passageway 34A releases the leading edge of the sheet and vacuum is applied to the trailing port 42A of the interfolding roll 20A to attract and hold the leading edge of the sheet onto the interfolding roll 24A. As the cutting and interfolding rolls 24A, 20A continue to rotate the sheet through the nip 38A, the vacuum passageways 34A, 36A adjacent to the next consecutive retracted blade 30A release the sheet, and vacuum is applied to the next set of vacuum ports 40A, 42A on the interfolding roll 20A to attract and hold the center portion of the sheet on the interfolding roll 20A. The trailing edge of the sheet is then rotated into the nip 38A where the upstream vacuum passageway 36A adjacent to the next consecutive extended blade 30A releases the trailing edge of the sheet, and vacuum is applied to the leading port 40A of the next set of vacuum ports 40A, 42A on the interfolding roll 24A, completing the transfer of the sheet onto the interfolding roll 20A. Rotation of the cutting roll 24A and the interfolding roll 20A continuously transfers sheets from the cutting roll 24A to the interfolding roll 20A.

The process described above with respect to the first guide rolls 16A, first cutting assembly 18A, and first interfolding roll 20A also applies to the operation of the second guide rolls 16B, second cutting assembly 18B, and second interfolding rolls 20B except that the second guide rolls 16B are fed web 12B that is separate from the web 12A fed to the first guide rolls 16A.

After the sheets are transferred to the cutting rolls 24A, 24B, the sheets move into the nip 44 between the two interfolding rolls 20A, 20B. The sheets are staggered with respect to the nip 44 so that a middle portion of a first sheet of one interfolding roll passes through the nip 44 at approximately the same time as leading and trailing edges of upstream and downstream sheets of the opposite interfolding roll. At this time, the vacuum port of the first interfolding roll attracts and retains the center of the first sheet and the leading and trailing edges of the opposing sheets to begin a fold in the first sheet and to capture the leading and trailing edges within the fold.

As the first interfolding roll 20A rotates with the sheet, a packer finger (not shown) pushes the middle portion along with the leading and trailing edges from the vacuum port to a position where the fold can be pressed with the leading and trailing edges of the opposing sheets being folded within the middle portion. As understood by those skilled in the art, this process continues alternately with the second interfolding roll 20B to form continuous stacks SI, S2 of interfolded sheets. Each sheet in the stacks SI, S2 includes a single fold 46 and two panels 48. One panel 48 is located upstream of the fold 46 (and is folded within the sheet above) and the other panel 48 is located downstream of the fold 46 (and is folded within the sheet below). In the illustrated embodiment, the length of one panel 48 is approximately equal to the distance between consecutive blades 30A, 30B (regardless of retracted or extended position) on the cutting roll 24A, 24B. Accordingly, the sheets extending between two extended blades 30A, 30B of the above-described configuration can be called two-panel sheets 50 after they are passed through the interfolding rolls 20A, 20B.

Some embodiments of the present invention create a separated stack S1 not interfolded with an adjacent stack S2. The interfolding apparatus 10 of the present invention creates a discontinuity, or a non-interfolded position 52 separating a completed interfolded stack SI below the non-interfolded position 52 and a new interfolded stack S2 being built above the non-interfolded position 52.

When a discontinuity is desired to complete a stack SI and to allow the completed stack SI to be non-interfolded with the adjacent stack S2, the sheet length created by the first cutting roll 24A is modified by adjusting the blades 30A on the first cutting roll 24A. In the illustrated embodiment, the original configuration, extending blades one, three, five, and seven, is changed such that only blades one, four, and seven are extended providing two retracted blades 30A between extended blades one and four, and two retracted blades 30A between extended blades four and seven. Rotation of the cutting roll 24A in this configuration will cut two sheets having a second length equal to the distance between the two consecutive extended blades 30A along the periphery of the cutting roll 24A. The second length is 1.5 times the length of the first length. After the second sheet is cut, the blade configuration is again adjusted to return to the original blade arrangement, which operates to cut sheets having the first length.

The sheets having the second length are transferred from the cutting roll 24A to the interfolding roll 20A to be passed through the nip 44 of the interfolding rolls 20A, 20B. The sheets having the second length are then interfolded with the sheets having the first length that continue to be supplied by the second interfolding roll 20B. The sheets having the second length form three-panel sheets 54 and the sheets having the first length continue to form two-panel sheets 50.

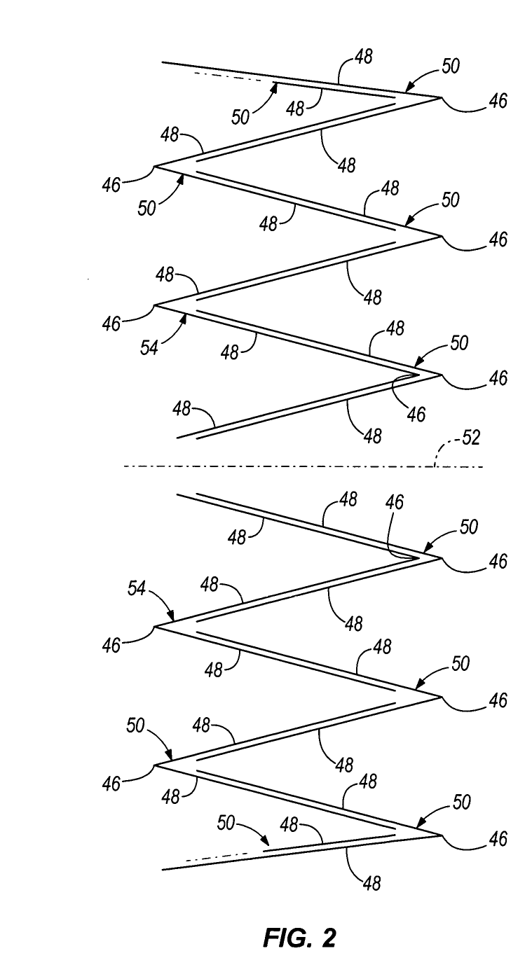

As shown in FIG. 2, interfolding the two sheets 54 having the second length with the continuous stream of sheets 50 having the first length results in a discontinuity or a non-interfolded position 52 separating a completed interfolded stack SI below the non-interfolded position 52 and a new interfolded stack S2 being built above the non- interfolded position 52. In some embodiments, a single count finger can be inserted into the non-interfolded position 52 and the movement and separation of the completed stack Si is simplified.

On the right side of the stacks S 1, S2, the sheets are consistently single-fold, two-panel sheets 50. On the left side, the two-fold, three-panel sheets 54 are interfolded and create the non-interfolded position 52 between them. In the illustrated embodiment, the first three-panel sheet 54 is used to align trailing edges of sheets from the first and second interfolding rolls 20A, 20B separating the stacks SI and S2. This alignment creates the non-interfolded position 52. The second three-panel sheet 52 is used to offset the sheets on opposing interfolding rolls 20A, 20B to allow the necessary overlap causing the creation of a new interfolded, continuous interfolded stack S2 of sheets

Various features of the invention are found in the following claims.

What is claimed is:

1. An interfolding apparatus comprising.
a first interfolding roll to which sheets of web product are supplied; and
a second interfolding roll to which additional sheets of web product are supplied, the interfolding rolls being rotatable to form a first number of folds in the sheets of web product, and the interfolding rolls being rotatable to form the first number of folds in some of the additional sheets and a second number of folds in at least one other of the additional sheets, the second number of folds being different than the first number of folds,
wherein the interfolding rolls are rotatable to interfold the sheets with the additional sheets having the first number of folds to form a stack of interfolded web product, and wherein the interfolding rolls are rotatable to interfold at least one of the sheets with at least one of the additional sheets having the second number of folds to form a discontinuity in the stack.

2. The interfolding apparatus of claim 1, wherein the first number of folds equals one and the second number of folds equals two.

3. The interfolding apparatus of claim 1, wherein the sheets have a first length, the additional sheets having the first number of folds have the first length, and the additional sheets having the second number of folds have a second length, the second length being different than the first length.

4. The interfolding apparatus of claim 3, wherein the interfolding rolls define a nip therebetween, and wherein a trailing edge of one of the sheets is aligned with a trailing edge of one of the additional sheets having the second length as the trailing edges pass through the nip.

5. The interfolding apparatus of claim 4, wherein a leading edge of a subsequent sheet is aligned with a leading edge of a subsequent additional sheet having the second length as the leading edges pass through the nip.

6. The interfolding apparatus of claim 3, wherein the second length is longer than the first length.

7. The interfolding apparatus of claim 3, further comprising cutting rolls positioned upstream of the interfolding rolls, wherein at least one of the cutting rolls is rotatable and adjustable to selectively cut the additional sheets to the first and second lengths.

8. The interfolding apparatus of claim 7, wherein the at least one cutting roll includes at least one blade, the blade being movable between cutting and retracted positions relative to the cutting roll, the blade being operable to cut the additional sheets from the web product during rotation of the cutting roll in the cutting position, and the blade not being operable to cut the additional sheets during rotation of the cutting roll in the retracted position.

9. An interfolding apparatus comprising.
a first interfolding roll to which sheets of web product are supplied, the sheets having a first length; and
a second interfolding roll to which additional sheets of web product are supplied, the second interfolding roll being adjacent to the first interfolding roll, some of the additional sheets having the first length and at least one other of the additional sheets having a second length, the second length being different than the first length,
wherein the interfolding rolls are rotatable to interfold the sheets with the additional sheets having the first length to form a stack of interfolded web product, and wherein the interfolding rolls are rotatable to interfold the sheets with at least one of the additional sheets having the second length to form a discontinuity in the stack.

10. The interfolding apparatus of claim 9, wherein the second length is longer than the first length.

11. The interfolding apparatus of claim 9, wherein the interfolding rolls are rotatable to form a first number of folds in the sheets, rotatable to form a first number of folds in the additional sheets having the first length, and rotatable to form a second number of folds in the additional sheets having the second length, the second number of folds being different than the first number of folds.

12. The interfolding apparatus of claim 9, wherein the first number of folds equals one and the second number of folds equals two.

13. The interfolding apparatus of claim 9, further comprising cutting rolls positioned upstream of the interfolding rolls, wherein at least one of the cutting rolls is rotatable and adjustable to selectively cut the additional sheets to the first and second lengths.

14. The interfolding apparatus of claim 13, wherein the at least one cutting roll includes at least one blade, the blade being movable between cutting and retracted positions relative to the cutting roll, the blade being operable to cut the additional sheets from the web product during rotation of the cutting roll in the cutting position, and the blade not being operable to cut the additional sheets during rotation of the cutting roll in the retracted position.

15. The interfolding apparatus of claim 9, wherein the interfolding rolls define a nip therebetween, and wherein a trailing edge of one of the sheets is aligned with a trailing edge of one of the additional sheets having the second length as the trailing edges pass through the nip.

16. The interfolding apparatus of claim 15, wherein a leading edge of a subsequent sheet is aligned with a leading edge of a subsequent additional sheet having the second length as the leading edges pass through the nip.

17. A method of interfolding sheets of web product, the method comprising:
providing an interfolding apparatus including a first interfolding roll and a second interfolding roll adjacent to the first interfolding roll;
supplying sheets of web product having a first length to the first interfolding roll;
supplying some additional sheets of web product having the first length to the second interfolding roll;
supplying at least one other of the additional sheets of web product having a second length to the second interfolding roll, the second length being different than the first length;
interfolding the sheets with the additional sheets having the first length;
forming a stack of interfolded web product;
interfolding the sheets with at least one of the additional sheets having the second length; and
forming a discontinuity in the stack.

18. The method of claim 17, wherein supplying other of the additional sheets includes supplying additional sheets having a second length 1.5 times the first length.

19. The method of claim 17, further comprising forming a first number of folds in the sheets, forming the first number of folds in the additional sheets having the first length, and forming a second number of folds in the additional sheets having the second length, the second number of folds being different than the first number of folds.

20. The method of claim 19, wherein forming a first number of folds includes forming one fold, and wherein forming a second number of folds includes forming two folds.

21. The method of claim 17, further comprising providing cutting rolls positioned upstream of the interfolding rolls, rotating at least one of the cutting rolls, and cutting the additional sheets to the first and second lengths.

22. The method of claim 21, further comprising moving at least one blade of the at least one cutting roll from a retracted position to a cutting position relative to the cutting roll, and cutting the additional sheets from the web product during rotation of the cutting roll in the cutting position.

23. The method of claim 17, further comprising passing a trailing edge of one of the sheets through a nip between the interfolding rolls, and passing a trailing edge of one of the additional sheets having the second length through the nip, and aligning the trailing edges with each other as the trailing edges pass through the nip.

24. The method of claim 23, further comprising passing a leading edge of a subsequent sheet through the nip, passing a leading edge of a subsequent additional sheet having the second length through the nip, and aligning the leading edges with each other as the leading edges pass through the nip.

25. A method of interfolding sheets of web product, the method comprising:
providing an interfolding apparatus including a first interfolding roll and a second interfolding roll adjacent to the first interfolding roll;
supplying sheets of web product to the first interfolding rolls;
supplying additional sheets of web product to the second interfolding roll;
forming a first number of folds in the sheets;
forming the first number of folds in some of the additional sheets;
forming a second number of folds in at least one other of the additional sheets, the second number of folds being different than the first number of folds;
interfolding the sheets with the additional sheets having the first number of folds;
forming a stack of interfolded web product;
interfolding at least one of the sheets with at least one of the additional sheets having the second number of folds; and
forming a discontinuity in the stack.

26. The method of claim 25, wherein forming a first number of folds includes forming one fold, and wherein forming a second number of folds includes forming two folds.

27. The method of claim 25, wherein supplying sheets of web product includes supplying sheets having a first length to the first interfolding roll, and wherein the act of supplying additional sheets includes supplying some of the additional sheets having the first length to the interfolding roll, and supplying other of the additional sheets having a second length to the second interfolding roll, the second length being different than the first length.

28. The method of claim 27, further comprising passing a trailing edge of one of the sheets through a nip between the interfolding rolls, and passing a trailing edge of one of the additional sheets having the second length through the nip, and aligning the trailing edges with each other as the trailing edges pass through the nip.

29. The method of claim 28, further comprising passing a leading edge of a subsequent sheet through the nip, passing a leading edge of a subsequent additional sheet having the second length through the nip, and aligning the leading edges with each other as the leading edges pass through the nip.

30. The method of claim 27, wherein supplying other of the additional sheets includes supplying additional sheets having a second length longer than the first length.

31. The method of claim 27, further comprising providing cutting rolls positioned upstream of the interfolding rolls, rotating at least one of the cutting rolls, and cutting the additional sheets to the first and second lengths.

32. The method of claim 31, further comprising moving at least one blade of the at least one cutting roll from a retracted position to a cutting position relative to the cutting roll, and cutting the additional sheets from the web product during rotation of the cutting roll in the cutting position.
